(19) United States
(12) Patent Application Publication
(10) Pub. No.: US 2019/0037996 A1
(43) Pub. Date: Feb. 7, 2019

(54) NAIL ART PALETTE

(71) Applicant: Miho AZUMA, Osaka (JP)

(72) Inventor: Miho AZUMA, Osaka (JP)

(21) Appl. No.: 16/076,372

(22) PCT Filed: Feb. 9, 2017
(86) PCT No.: PCT/JP2017/004693

§ 371 Date: Aug. 8, 2018

(30) Foreign Application Priority Data
Feb. 12, 2016 (JP) 2016-024465

(51) Int. Cl. A45D 29/00

(52) U.S. Cl. CPC A45D 29/00; B44D 3/02

(57) ABSTRACT

A nail art treatment tool (1) as a nail art palette is made of a plastic molding, and includes a thin sheet-shaped main body (2). The main body (2) includes: a tray part (5) on which a nail agent is taken out and/or mixed with another nail agent; and a bendable pinching part (6). The pinching part (6) is disposed at least at one corner of the main body (2), and is bendable along a folding groove (3) formed in a front surface of the main body (2). When the nail art treatment tool (1) is placed on a horizontal desk, the main body (2) is curved so as to gradually separate from the desk from a center of the main body (3) to an outer peripheral edge of the main body (2).

### TECHNICAL FIELD

The present invention relates to a nail art treatment tool, and particularly to a nail art palette that is used when a gel nail treatment is performed.

### BACKGROUND ART

As a method for decorate fingernails and toenails, gel nails using nail agents including photocurable resin are known, in addition to nail agents for manicure (also referred to as nail polish, lacquer enamel, and the like). The gel nails thus treated are hard and scratch-resistant compared to lacquer enamel for manicure. Thus, gloss and color development of the gel nails last for a long time (several weeks), which also serves as a protector of the nails. Also, since such beautiful nails give a sense of contentment, the gel nails have become very popular.

For example, Patent Document 1 discloses a gel nail treatment method. In this method, generally, the surface and the tip of the nail are suitably shaped/prepared, and then each gel nail agent is repeatedly applied and cured in the order of a base gel, a color gel and a top gel. As shown in FIG. 5, when applying the nail agent, first, the center of a nail 101 in the width direction is brushed with the nail agent, and then the left side and the right side are respectively brushed, by a nail brush 102, along the longitudinal direction of the nail 101. Through these gel nail procedures, the nail agent is applied over the entire nail 101 finely and evenly.

When applying the nail agent, sometimes the nail brush 102 is directly dipped in the nail agent in a container so that the nail brush 102 is alternately applied onto the nail 101 and put in the container. However, when a plurality of staff members (manicurists) uses the same nail agents in a nail salon or the like, the above manner is not likely to be adopted. Normally, an amount of nail agent necessary for one time treatment is taken out from the container in advance, also taking into account the preservability of the nail agent. At this time, a small amount of nail agent taken out from the container is put on a small sheet of aluminum foil cut into a rectangular shape so as to apply it onto the nail 101.

### PRIOR ART DOCUMENT

### Patent Document

Patent Document 1: JP 2015-189668 A

### SUMMARY OF THE INVENTION

### Problem to Be Solved by the Invention

When the aluminum foil is used as a tray or a palette for the nail agent as described above, it is time consuming to prepare small sheets of aluminum foil by cutting, apart from the fact that it is not pleasing in the eye. Moreover, when a plurality of staff members treats respective clients' nails in a nail salon or the like, the staff members should share multiple containers of the nail agents. Thus, the palettes for the nail agents become more important. In consideration of multiple staff members working at the same time, it is more time consuming and ineffective to prepare small sheets of aluminum foil by cutting in the conventional art.

On the sheet of aluminum foil during the nail art treatment, sometimes multiple nail agents are mixed to make a color, or small powder such as glitters are mixed with a nail agent, thereby making a nail agent with a required color. Since the aluminum foil is soft, it is difficult to mix the nail agents thereon unless the aluminum foil is firmly pressed with one hand while the nail brush is held by the other hand. Also, the aluminum foil may be torn, thus it is not easy to deal with. Furthermore, when confirming the tone of the mixed nail agent, it is hard to see it due to reflection of light on the aluminum foil.

The present invention was made in consideration of the above problems, an object of which is to provide a nail art palette as a nail art treatment tool that is easy to handle when performing a nail art treatment and that is suitable for putting nail agents thereon from containers so as to mix the nail agents to prepare a nail agent depending on the purpose.

### Means for Solving the Problem

In order to achieve the above object, the present invention provides a nail art palette for a nail art treatment. The nail art palette is made of a plastic molding and includes a thin sheet-shaped main body. The main body includes: a tray part on which a nail agent is taken out and/or mixed with another nail agent; and a bendable pinching part disposed at least at one corner of the main body. The pinching part is bendable along a folding groove formed in a front surface of the main body.

With the above-described configuration, the nail art palette can have a strength sufficient for taking out/ mixing the nail agent thereon. Furthermore, by wiping off the remaining nail agent after use of the nail art palette, it can be repeatedly used. Since the nail art palette is provided with the bendable pinching part, it is easy to pinch the thin sheet-shaped main body. Thus, it can be easily held and treated even by a hand with long nails.

Also, in the present invention, a nail art palette for a nail art treatment is made of a plastic molding and includes a thin sheet-shaped main body. The main body includes a tray part on which a nail agent is taken out and/or mixed with another nail agent. When the nail art palette is placed on a horizontal desk, the main body is curved so as to gradually separate from the desk from a center of the main body to the outer peripheral edge of the main body. In the front surface of the main body, a surrounding groove is formed inside the outer peripheral edge of the main body.

With the above-described configuration, the nail art palette can have a strength sufficient for taking out/mixing the nail agent thereon. Furthermore, by wiping off the remaining nail agent after use of the nail art palette, it can be repeatedly used. Since the main body is curved, it is easy to pinch and pick up the thin sheet-shaped main body.

Furthermore, the nail agent put on the main tray is not likely to flow out.

As a specific configuration of the above-described nail art palette, it is preferable that the main body is colorless and transparent. This configuration ensures the visibility of the tone/color of the nail agent that is put on the main body. Also, it is possible to put the main body itself on the nail so as to confirm whether the nail agent that is on the main tray matches the finger that can be seen through the transparent main body. Thus, it is possible to image, with ease, the finished gel nails.

Also, in the above-described nail art palette, it is preferable that, in the front surface of the main body, a surrounding groove is formed inside the outer peripheral edge of the main body. With this configuration also, the nail agent that is put on the main body is not likely to flow outside the main body. Thus, the nail art palette is suitably used to mix a plurality of kinds of nail agents on the main body.

### Effects of the Invention

The nail art palette of the present invention is very easy to deal with, that is, it is easily picked up even by a hand with long nails, which serves to perform the nail art treatment efficiently.

### BRIEF DESCRIPTION OF THE DRAWINGS

[FIG. 1]

FIG. 1 is a plan view of a nail art treatment tool as a nail art palette according to an embodiment of the present invention.

[FIG. 2]

FIG. 2 is a side view of the nail art treatment tool.

[FIG. 3]

FIG. 3 is a perspective view of the nail art treatment tool.

[FIG. 4]

FIG. 4 is a perspective view showing a state of the nail art treatment tool when it is used.

[FIG. 5]

FIG. 5 is an explanatory view illustrating an example of the conventional gel nail treatment method. [FIG. 6]

FIG. 6 is a photograph showing the nail art palette that is being picked up using a pinching part according to the embodiment of the present invention.

[FIG. 7]

FIG. 7 is a reference photograph showing a state in which one is trying to pick up a flat sheet by a hand with long nails, as a comparable example.

[FIG. 8]

FIG. 8 is a reference photograph showing a state in which one is picking up a flat sheet by a hand without long nails, as a comparable example.

### MODE FOR CARRYING OUT THE INVENTION

Hereinafter, a nail art treatment tool as a nail art palette according to an embodiment of the present invention will be described with reference to the drawings. The nail art treatment tool is mainly used for a gel nail treatment to fingernails or toenails, and is generally called as a nail gel palette, a manicure palette or the like. Generally, the gel nail here means: a method including the steps of applying a gel type nail agent containing photocurable resin onto the nail, curing the nail agent by light irradiation, and thus unifying the nail agent with the nail; the kinds of the above nail agents; and also a cured nail agent itself.

A nail art treatment tool 1, which is made of a plastic molding, includes a thin sheet-shaped or plate-shaped main body 2. The main body 2 is formed in a substantially rectangular shape in plan view. The thickness of the main body 2 is not more than 2 mm. Preferably, it is less than 1 mm.

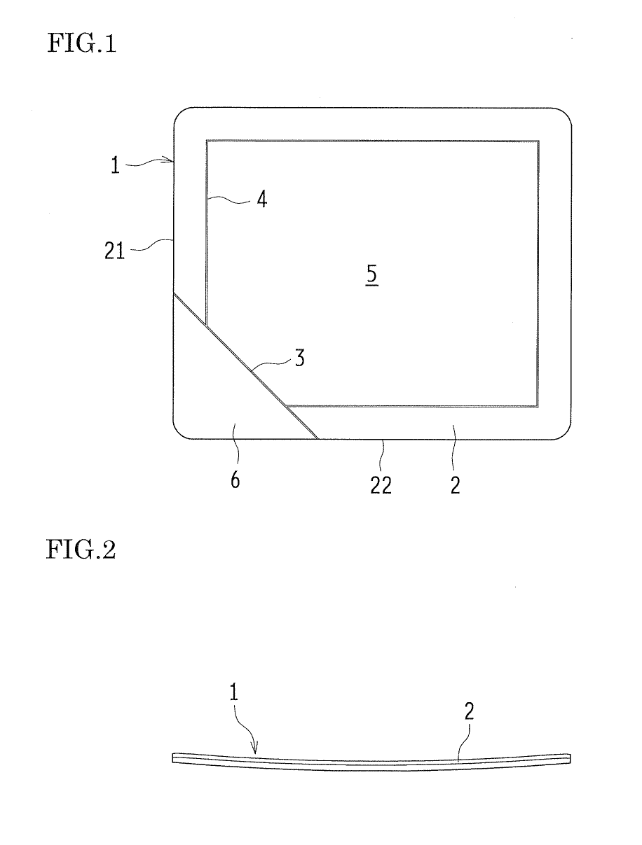

In the embodiment as shown in FIG. 1, the main body 2 is constituted by: a pair of long sides; a pair of short sides; and four corners connecting the long sides and the short sides. Each outer edge of the four corners has a rounded shape. Taking into account easiness to handle, the main body 2 is formed so as to have a size, for example, of 5 cm×6 cm, or 6 cm×7 cm. Thus, the main body 2 is made to have a size that can just fit in the palm of the hand.

The main body 2 is colorless and transparent. The plastic molding (plastic sheet) as the main body 2 is preferably made of a colorless and transparent thermoplastic resin material that has an appropriate strength and surface smoothness, and furthermore impermeability against the nail agent. Examples of the thermoplastic resin material include: polyvinyl chloride (PVC); polyethylene terephthalate (PET); polycarbonate (PC); polymethyl methacrylate (PMMA); polypropylene (PP); and polystyrene (PS). The main body 2 can be formed by vacuum forming, pressure forming, thermoforming, press forming or the like.

The main body 2 is provided with a bendable pinching part 6 that includes at least one corner of the four corners. In the embodiment as exemplarily shown, a folding groove 3 is formed in the main body 2 so as to be a line that connects a short side 21 and a long side 22 adjacent to the short side 21. By the folding groove 3, the main body 2 is divided into a tray part 5 including three corners and the pinching part 6 including one corner. The pinching part 6 is a substantially triangle-shaped small area outside the folding groove 3. The pinching part 6 is bendable along the folding groove 3.

The folding groove 3 is formed in one surface of the main body 2 as a shallow groove line having a cross section of a substantially V shape or a substantially semicircular shape. The surface in which the folding groove 3 is formed is a front surface of the main body 2 of the nail art treatment tool 1.

As shown in FIG. 2, the thin sheet-shaped main body 2 is entirely curved. In the embodiment as exemplarily shown, when the main body 2 is placed, with its front surface upside, on a horizontal desk, the main body 2 is entirely curved in a direction in which the main body is separated from the desk. With this configuration, when the main body 2 is placed on the desk, the four corners are spaced apart from the desk while the center part of the main body 2 makes contact with the desk. The upside surface (front surface) of the main body 2 in this state has the folding groove 3.

In the front surface of the main body 2, a surrounding groove 4 is formed inside the outer peripheral edge of the main body 2. Similarly to the folding groove 3, the surrounding groove 4 is formed as a shallow groove line having a cross section of a substantially V shape or a substantially semicircular shape.

Each of the folding groove 3 and the surrounding groove 4 in the front surface of the main body 2 is a groove line that is formed thinner than the other part of the main body 2 using a cutting tool or the like. The folding groove 3 and the surrounding groove 4 are the groove lines here, however, they may be made as perforations or the like that cannot be cut out.

In the example as shown in FIG. 1, the size of the main body 2 is 5 cm×6 cm. The surrounding groove 4 is disposed along, and 5 mm inside from, the outer peripheral edge of the main body 2. The start end and the terminal end of the surrounding groove 4 are connected to the folding groove 3.

The nail art treatment tool 1 as described above can be used as a tray or palette on which a small amount of nail agent is taken out from a container and used when the gel nail treatment is applied onto fingernails or toenails. The nail agent is a fluid material containing photocurable resin, and is normally sealed and stored in a container with a cap. On the tray part 5 of the nail art treatment tool 1, the necessary amount of nail agent can be taken out from the container using the nail brush.

For example, a plurality of kinds of nail agents may be taken out on the tray part 5 and mixed using the nail brush so as to obtain a desired color of nail agent. Furthermore, powder or small pieces such as glitters may be mixed with the nail agent.

Since the main body 2 is curved so as to separate from the desk and furthermore has the surrounding groove 4 along the outer peripheral edge, it can receive the nail agents taken out from the containers so that the nail agents are mixed without flowing out from the main body 2. Also, since the manicurist can move the nail brush using the surrounding groove 4 of the main body 2 as a guide, it is possible to make a desired nail agent inside the surrounding groove 4.

Since the main body 2 is colorless and transparent, it ensures the visibility of the nail agent put on the main body 2, which serves to easily confirm the tone of the color. For example, after the nail agent is prepared on the main body 2, this main body 2 can be put on the nail of a person treated so as to easily confirm whether the color/tone of the prepared nail agent looks good on the finger seen through the transparent main body 2. In this way, not only the manicurist but also the person treated (client) can image, with ease, the finished gel nails, which also facilitates adjustment of the tone.

When carrying the nail art treatment tool 1, as shown in FIG. 4, the pinching part 6 is bent toward the front surface side along the folding groove 3 so that the pinching part 6 is in a raised state. Thus, the pinching part 6 is easily pinched to pick up the main body 2.

It is difficult to pinch up a thin sheet-like thing by the fingertips having gel nails. It is further difficult to do so when such treated nails are long. In contrast, the nail art treatment tool 1 has the main body 2 that is curved entirely and thus not stuck on the desk, and further has the pinching part 6. Thus, the main body 2 can be easily picked up or carried even by the fingertips having long, treated nails, which serves to perform the nail art treatment efficiently.

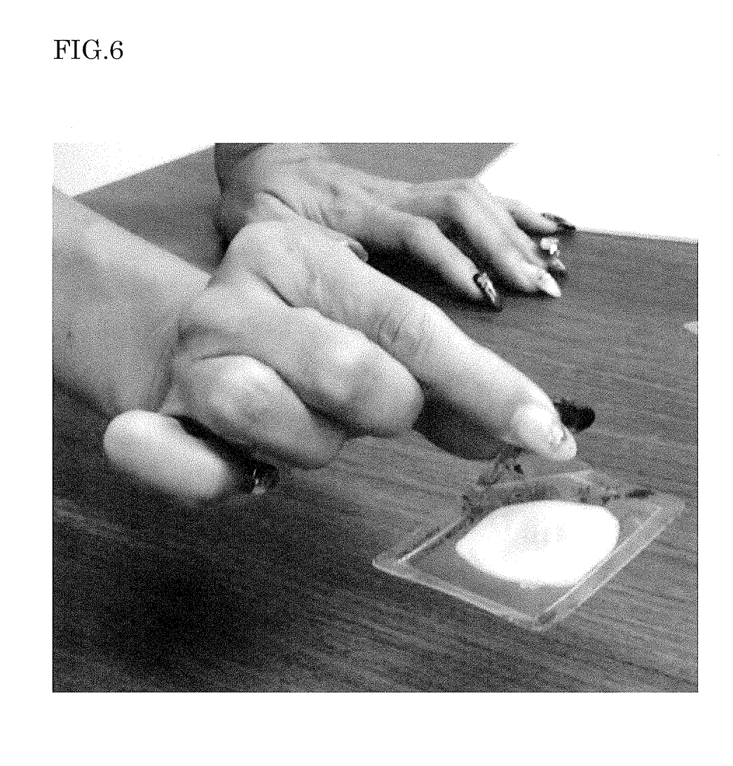

Since the main body 2 is provided with the bendable pinching part 6, it can be easily picked up even by a hand with long nails, as exemplarily shown in FIG. 6. Thus, it is easy to deal with.

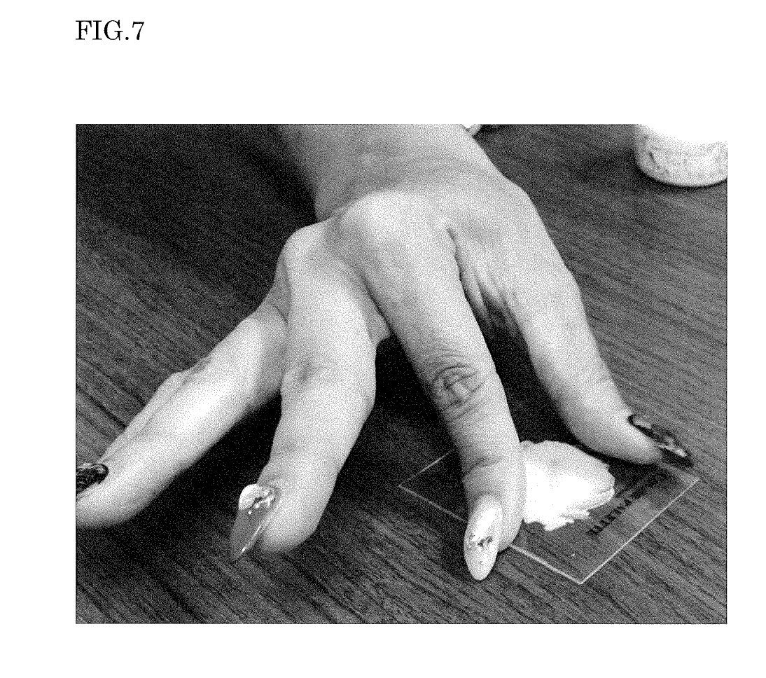

Here, a case is assumed, in which a thin plate-like plastic molding is picked up by a hand with long nails. As exemplarily shown in FIG. 7, in such a case, since the tips of the nails are caught by the surface of the desk, the fingertips cannot work well to make contact with the external edge of the plastic molding. As a result, it is necessary to pick up the plastic molding by pinching the surface thereof by the pads of the fingers. As the nail agent is on the surface, the nail agent may be adhered to the fingertips.

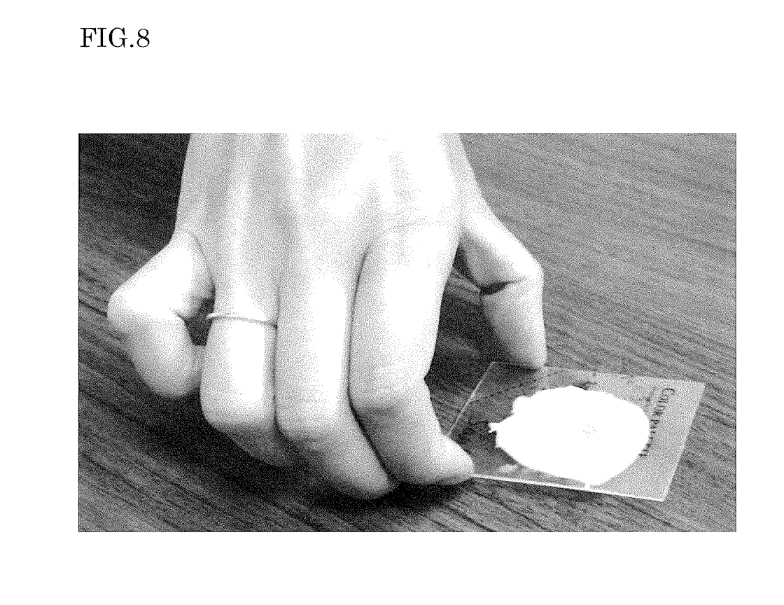

Compared to the above, as exemplarily shown in FIG. 8, the thin plate-like plastic molding can be picked up by use of the fingertip or by hooking the tips of the nails on the external edge of the plastic molding, when using a hand without long nails.

In many cases, the gel nail treatment is performed to a client by a professional manicurist in a nail salon or the like. Thus, the manicurist often has long gel nails that serve as nail design samples. In the embodiment as exemplarily shown, the nail art treatment tool 1 can be easily picked up or moved even by a hand having gel nails or long gel nails, which results in excellent operability and improved workability.

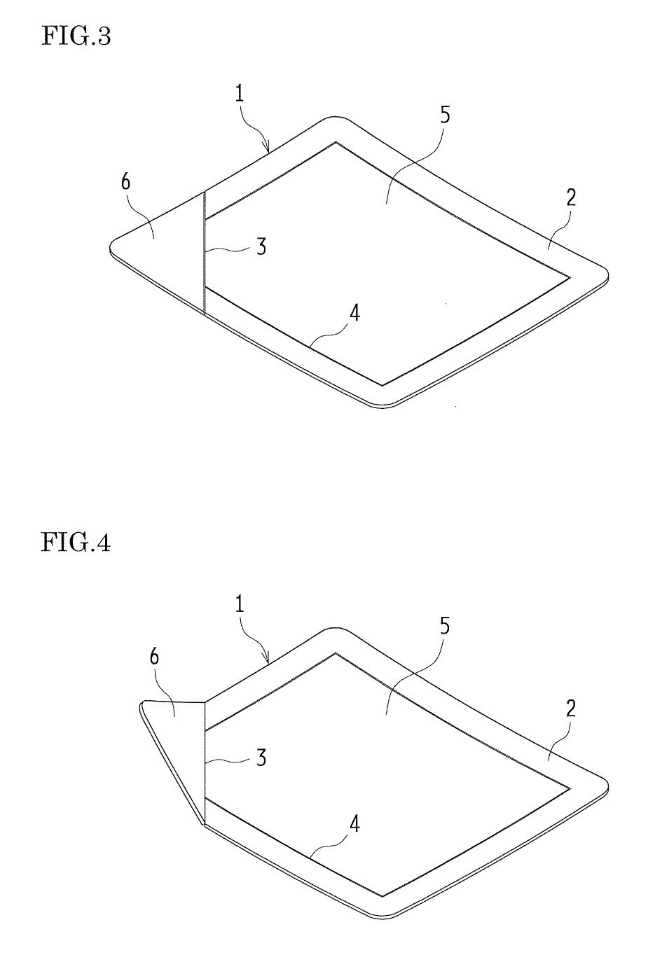

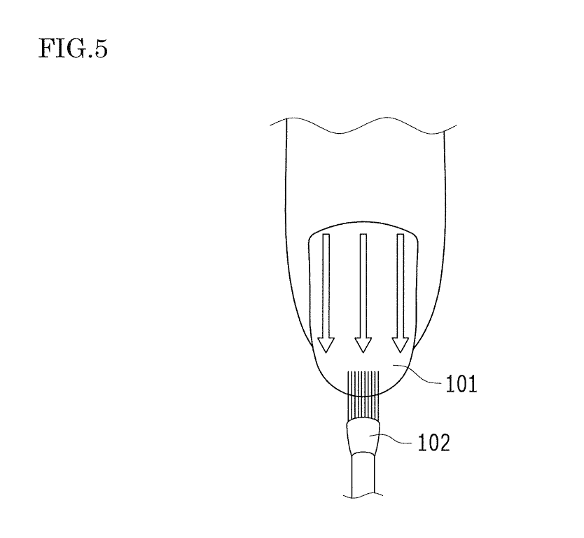

Since the pinching part 6 is bendable, when the nail art treatment tool 1 is not used, the bent pinching part 6 can be returned to an original flat state along the folding groove 3 as shown in FIG. 3. Due to the shape as shown in FIG. 3, a plurality of nail art treatment tools 1 can be stacked up, or arranged vertically, which results in space-saving storage of them.

After applying the gel nails, the nail agent that remains on the main body 2 is wiped off and removed. For example, similarly to a manner in which an uncured nail agent is wiped off from the finished gel nail, the front surface of the main body 2 is wiped off with nail wipe cloth impregnated with a removing liquid so as to remove the rest of the nail agent, thereby cleaning the front surface of the main body 2. In this way, the nail art treatment tool 1 is not needed to be disposable, which is economical since it can be repeatedly used.

In the present invention, the external shape of the main body 2 is not limited to the substantially rectangular shape. It may have any shape such as a triangle shape, an oblong shape, a heart shape and the like, provided that the pinching part can be disposed. The front surface of the main body 2 may be beautifully printed, if desired, so as to match it to the atmosphere of the nail salon or the like, or to suit the taste of a person treated.

The present invention may be embodied in other forms without departing from the gist or essential characteristics thereof. The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein.

This application claims priority based on Patent Application No. 2016-024465 filed in Japan on Feb. 12, 2016. The entire contents thereof are hereby incorporated in this application by reference.

### Industrial Applicability

The present invention can be suitably used to a gel nail treatment.

### Description of Reference Numerals

1 Nail art treatment tool (nail art palette)
2 Main body
3 Folding groove
4 Surrounding groove
5 Tray part
6 Pinching part

1. A nail art palette for a nail art treatment, the nail art palette being made of a plastic molding and comprising a thin sheet-shaped main body,
wherein the main body includes: a tray part on which a nail agent is taken out and/or mixed with another nail agent; and a bendable pinching part disposed at least at one corner of the main body, and
wherein the pinching part is bendable along a folding groove formed in a front surface of the main body.

2. The nail art palette according to claim 1,
wherein, when the nail art palette is placed on a horizontal desk, the main body is curved so as to gradually separate from the desk from a center of the main body to an outer peripheral edge of the main body.

3. The nail art palette according to claim 1,
wherein, in the front surface of the main body, a surrounding groove is formed inside an outer peripheral edge of the main body.

4. A nail art palette for a nail art treatment, the nail art palette being made of a plastic molding and comprising a thin sheet-shaped main body,
wherein the main body includes a tray part on which a nail agent is taken out and/or mixed with another nail agent,
wherein, when the nail art palette is placed on a horizontal desk, the main body is curved so as to gradually separate from the desk from a center of the main body to an outer peripheral edge of the main body, and
wherein, in a front surface of the main body, a surrounding groove is formed inside the outer peripheral edge of the main body.

5. The nail art palette according to claim 1,
wherein the main body is colorless and transparent.

6. The nail art palette according to claim 2,
wherein, in the front surface of the main body, a surrounding groove is formed inside an outer peripheral edge of the main body.

7. The nail art palette according to claim 2,
wherein the main body is colorless and transparent.

8. The nail art palette according to claim 3,
wherein the main body is colorless and transparent.

9. The nail art palette according to claim 4,
wherein the main body is colorless and transparent.

10. The nail art palette according to claim 6,
wherein the main body is colorless and transparent.
